(19) United States
(12) Patent Application Publication
(10) Pub. No.: US 2021/0172611 A1
(43) Pub. Date: Jun. 10, 2021

(54) SAFE HEATER BASED ON ENVIRONMENTAL ANALYSIS

(71) Applicant: YUYAO HENGZHENG METALWARE CO., LTD., ZHEJIANG (CN)

(72) Inventor: Gaoli Ge, Zhejiang (CN)

(21) Appl. No.: 16/970,140

(22) PCT Filed: Apr. 12, 2019
(86) PCT No.: PCT/CN2019/082528

§ 371 Date: Jan. 20, 2021

(30) Foreign Application Priority Data
Jun. 13, 2018 (CN) 201810609266.4

(51) Int. Cl. F24D 13/00; F24D 19/10; G01S 15/06; G06T 7/70

(52) U.S. Cl. CPC F24D 13/00; G06T 7/70; G01S 15/06; F24D 19/1096

(57) ABSTRACT

The present invention relates to a safe heater based on environmental analysis, wherein the heater comprises: a heater body, which comprises a housing, a safe metal cover, a reflective cover and a power switch, wherein the power switch is used for connecting a 220V alternating current, the safe metal cover is arranged at the periphery of the reflective cover, and the housing is arranged at the periphery of the safe metal cover; an image collection device for performing panoramic image data collection on the position where the heater body is located so as to obtain and output a corresponding high-definition panoramic image; an ultrasonic emission device, which is arranged on the image collection device, and is used for emitting an ultrasonic signal towards the ground and recording the time when the ultrasonic signal is emitted; and an ultrasonic receiving device, which is arranged on the image collection device, is located near the ultrasonic emission device and is used for facing the ground to receive the ultrasonic signal reflected by the ground and emitted by the ultrasonic emission device. The safety performance of the heater can be improved by the present invention.

### TECHNICAL FIELD

The present invention relates to the field of household equipment, in particular to a safe heater based on environmental analysis.

### BACKGROUND ART

Electric heaters can be divided into oil heaters, air heaters and radiant heaters in terms of appearance. Oil heaters are the most common electric heaters in the market, and their common appearance is very similar to radiant heaters at home. Air heaters can be divided into bathroom type and non-bathroom type. Bathroom heaters are small in shape, with powerful air blow, rapid rise in temperature and totally enclosed to ensure safety during application. The table and wall heaters look like air conditioners. Radiant heaters are very similar to electric fans in appearance, except that the fan blades and rear cover are replaced by electric heating assembly and arc reflector respectively.

To keep up with people's increasing demand for product quality, in addition to their heating performance, safety of electric heaters is also a highly-valued and important factor.

### SUMMARY OF THE INVENTION

In order to solve the technical problem of a heater unable to detect any explosive substance in its surrounding environment, the present invention provides a safe heater based on environmental analysis. The average value of the R components is subjected to intra-region sorting and inter-region soiling, the directional processing mode of the image is determined, and targeted sharpening processing is carried out on each front-ranking image region in ambiguity. A CPLD chip is adopted to realize noise detection and analysis of the image, and basing on this, a data correction device is adopted to perform adaptive correction of the segmentation threshold, so that the accuracy of follow-up detection is improved. The current position of the image collection device is determined by adopting an ultrasonic detection mode, and in order to improve the precision of position detection, a temperature speed comparison table is introduced to store the ultrasonic transmission speed corresponding to each temperature range. Meanwhile, a vertical control motor is adopted to correct the current position of the image collection device in real time, to ensure the quality of collected image. Basing on the data processing, a high-precision customized identification is carried out on the existence condition of the firecracker around the heater, so that the explosion of the firecracker caused by the heater is avoided.

According to one aspect of the present invention, a safe heater based on environmental analysis is provided, wherein the heater comprises:

a heater body, which comprises a housing, a safe metal cover, a reflective cover and a power switch, wherein the power switch is used for connecting a 220V alternating current, the safe metal cover is arranged at the periphery of the reflective cover, and the housing is arranged at the periphery of the safe metal cover.

More specifically, the safe heater based on environmental analysis further comprises: an image collection device for performing panoramic image data collection on the position where the heater body is located so as to obtain and output a corresponding high-definition panoramic image; an ultrasonic emission device, which is arranged on the image collection device, and is used for emitting an ultrasonic signal towards the ground and recording the time when the ultrasonic signal is emitted; and an ultrasonic receiving device, which is arranged on the image collection device, is located near the ultrasonic emission device and is used for facing the ground to receive the ultrasonic signal reflected by the ground and emitted by the ultrasonic emission device, and recording the time when the ultrasonic signal reflected by the ground and emitted by the ultrasonic emission device is received.

More specifically, the safe heater based on environmental analysis further comprises: an air temperature detection device, which is arranged on the image collection device, and is used for detecting the air temperature of the environment where the image collection device is located as a current air temperature output; an embedded processing device, which is arranged on the image collection device, is connected respectively with the air temperature detection device, the ultrasonic emission device and the ultrasonic receiving device, and is used for calculating the vertical height of the image collection device to the ground to be output as the current height based on the current air temperature, the time of ultrasonic signal emitted and the time of ultrasonic signal received; a FLASH storage device, which is connected with the embedded processing device, and is used for storing a temperature speed comparison table, wherein the temperature speed comparison table is used for storing the ultrasonic transmission speed corresponding to each temperature range, wherein the temperature speed comparison table is using the temperature range as the index value, and the FLASH storage device is further used for storing a preset height, wherein the preset height is the shooting height set by the image collection device; a vertical control motor, which is connected with the embedded processing device and the image collection device, is used for receiving the current height and the preset height, and controlling the image collection device to adjust the position of the image collection device from the current height to the preset height, wherein the vertical control motor is also used for sending an adjusted signal after adjusting the position of the image collection device from the current height to the preset height; a noise identification device, which is connected with the image collection device, and is used for receiving the high-definition panoramic image and performing noise type analysis on the high-definition panoramic image to obtain the various noise types and the maximum amplitude corresponding to each noise type in the high-definition panoramic image, sorting the various noise types based on the order of the maximum amplitude from large to small, and taking the five types of noise with largest amplitude as five to-be-processed noise types to be output; and the noise identification device is realized by a CPLD chip, wherein a memory is integrated in the CPLD chip, which is used for storing a type weight comparison table, wherein the type weight comparison table saves the influence coefficient of each noise type on the binarization threshold value, and is further used for storing an initialization binarization threshold value; a data correction device, which is connected with the noise identification device, and is used for receiving the five to-be-processed noise types, the initialization binarization threshold value and the type weight comparison table, to determine the five influence coefficients corresponding respectively to the five to-be-processed noise types basing on the type weight comparison table, and to carry out correction processing in sequence on the initialization binarization threshold value by adopting the five influence coefficients, so as to obtain and output the correction threshold value after the correction processing is finished; a normalization processing device, which is connected with the data correction device, to perform binarization processing on the high-definition panoramic image by adopting the correction threshold value, so as to obtain and output a to-be-detected image; an image equalization device, which is connected with the normalization processing device, is used for receiving the to-be-detected image, and performing white balance processing on the to-be-detected image, so as to obtain and output a corresponding white balance image; a component extraction device, which is connected with the image equalization device, is used for receiving the white balance image, and performing average value calculation on the R components of each region of the white balance image, so as to obtain the average value of each R component of each region, wherein the size of each region is the same; a component analysis device, which is connected with the component extraction device, and is used for receiving the average value of each R component of each region, sorting the average value of each R component of each region, outputting a plurality of regions ranked in front of the preset quantity and a plurality of regions ranked at the end of the preset quantity as various to-be-processed regions, and outputting various regions in the white balance image apart from those to-be-processed regions as various background regions; a directional sharpening device, which is connected with the component analysis device, is used for receiving the various to-be-processed regions and the various background regions, and performing the following operations for each to-be-processed region: performing corresponding sharpening processing on the to-be-processed regions based on the ambiguity of the to-be-processed regions to obtain the corresponding sharpening processing regions, wherein the greater the degree of ambiguity, the greater the strength of performing the corresponding sharpening processing on the to-be-processed regions will be, and the dynamic distribution range of the to-be-processed regions is used to express the ambiguity, and the wider the dynamic distribution range, the smaller the degree of ambiguity will be; a data fusion device, which is connected to the directional sharpening device, and is used for receiving a plurality of sharpening processing regions and fusing the plurality of sharpening processing regions with the various background regions to obtain and output a fusion processing image; and a firecracker detection device, which is connected to the data fusion device, and is used for receiving the fusion processing image, searching for a corresponding firecracker sub-image from the fusion processing image basing on a firecracker image feature, identifying a plurality of firecracker pixels in the firecracker sub-image basing on a preset firecracker upper limit threshold and a preset firecracker lower limit threshold, fitting a plurality of firecracker pixels into a firecracker region, determining the area percentage in the firecracker sub-image occupied by the firecracker region, and sending a firecracker detection signal when the area percentage exceeds a limit.

More specifically, in the safe heater based on environmental analysis: in the firecracker detection device, a firecracker undetected signal is sent when the area percentage limit is not exceeded.

More specifically, in the safe heater based on environmental analysis: the power switch is connected with the firecracker detection device, and is used for interrupting connection between the power switch and the 220-volt alternating current when the firecracker detection signal is received.

More specifically, in the safe heater based on environmental analysis: the power switch is connected with the firecracker detection device, and is used for maintaining the connection between the power switch and the 220-volt alternating current when the undetected signal of the firecracker is received.

More specifically, in the safe heater based on environmental analysis: calculating the average value of R components of each region of the white balance image in the component extraction device, so as to obtain the average value of each R component of each region, which includes: obtaining the R component values of each pixel point of each region basing on an operation formula of YUV to RGB, sorting the R component values of each pixel point from large to small, and taking the R component value of the pixel point in the center as the average value of R component of the corresponding region.

More specifically, in the safe heater based on environmental analysis: the image collection device is further used for starting collecting operation of the high-definition panoramic image when receiving an adjustment complete signal sent by the vertical control motor.

More specifically, in the safe heater based on environmental analysis: the embedded processing device calculates the vertical height of the image collection device to the ground based on the current air temperature, the time of ultrasonic signal emitted and the time of ultrasonic signal received, which includes: obtaining a temperature range comparison table from the FLASH storage device, determining a temperature range where the current air temperature is located to obtain a corresponding ultrasonic transmission speed from the temperature speed comparison table to serve as a current transmission speed, and calculating the vertical height of the image collection device to the ground basing on the current transmission speed, the time of ultrasonic signal emitted and the time of ultrasonic signal received.

### DETAIL DESCRIPTION OF IMPLEMENTATION METHOD

The following is a detail description of embodiments of the safe heater based on environmental analysis of the present invention.

There are three forms of electric heaters, namely convection type, energy storage type and microcirculation type, wherein the convection type electric heaters adopt an electric heating coil as the heating element, and is heated by heating convection of air. A convection type electric heater is small in size, rapid in starting, fast in heating, accurate in control and simple and convenient in installation and maintenance. An energy storage type electric heater adopts an energy storage material. It can store energy when the electricity cost is low at night, and releases heat during daytime. However, the volume of this type of electric heater is relatively large and the comfort of heating is poor. A microcirculation electric heater is a novel electric heater filled with a heat conduction medium in the radiator and utilizes circulation of the medium in the radiator to raise the indoor temperature. It is reliable in operation and relatively high in heating efficiency. The electric heating oil heater belongs to this type of heater. Among the three electric heaters, the convection type electric heater is most common. At present, almost all electric heaters for civil application being sold in the household appliance market is convection type.

Safety monitoring is still not an important factor of consideration for the existing electric heaters, and the heating efficiency is still the most important factor of attention for existing electric heaters.

In order to overcome the shortcomings, the safe heater based on environmental analysis designed by the present invention can effectively solve the corresponding technical problems.

The safe heater based on environmental analysis shown in the embodiments of the present invention comprises:

a heater body, which comprises a housing, a safe metal cover, a reflective cover and a power switch, wherein the power switch is used for connecting a 220V alternating current, the safe metal cover is arranged at the periphery of the reflective cover, and the housing is arranged at the periphery of the safe metal cover.

Next, the specific structure of the safe heater based on environmental analysis of the present invention is further described.

The safe heater based on environmental analysis further comprises:
an image collection device for performing panoramic image data collection on the position where the heater body is located so as to obtain and output a corresponding high-definition panoramic image;
an ultrasonic emission device, which is arranged on the image collection device, and is used for emitting an ultrasonic signal towards the ground and recording the time when the ultrasonic signal is emitted;
and an ultrasonic receiving device, which is arranged on the image collection device, is located near the ultrasonic emission device and is used for facing the ground to receive the ultrasonic signal reflected by the ground and emitted by the ultrasonic emission device, and recording the time when the ultrasonic signal reflected by e ground and emitted by the ultrasonic emission device is received.

The safe heater based on environmental analysis further comprises:

an air temperature detection device, which is arranged on the image collection device, and is used for detecting the air temperature of the environment where the image collection device is located as a current air temperature output;

an embedded processing device, which is arranged on the image collection device, is connected respectively with the air temperature detection device, the ultrasonic emission device and the ultrasonic receiving device, and is used for calculating the vertical height of the image collection device to the ground to be output as the current height based on the current air temperature, the time of ultrasonic signal emitted and the time of ultrasonic signal received;

a FLASH storage device, which is connected with the embedded processing device, and is used for storing a temperature speed comparison table; wherein the temperature speed comparison table is used for storing the ultrasonic transmission speed corresponding to each temperature range; the temperature speed comparison table is using the temperature range as the index value, and the FLASH storage device is further used for storing a preset height, wherein the preset height is the shooting height set by the image collection device;

a vertical control motor, which is connected with the embedded processing device and the image collection device, is used for receiving the current height and the preset height, and controlling the image collection device to adjust the position of the image collection device from the current height to the preset height, wherein the vertical control motor is also used for sending an adjusted signal after adjusting the position of the image collection device from the current height to the preset height;

a noise identification device, which is connected with the image collection device, and is used for receiving the high-definition panoramic image and performing noise type analysis on the high-definition panoramic image to obtain the various noise types and the maximum amplitude corresponding to each noise type in the high-definition panoramic image, sorting the various noise types based on the order of the maximum amplitude from large to small, and taking the five types of noise with largest amplitude as five to-be-processed noise types to be output; and the noise identification device is realized by a CPLD chip, wherein a memory is integrated in the CPLD chip, which is used for storing a type weight comparison table, wherein the type weight comparison table saves the influence coefficient of each noise type on the binarization threshold value, and is further used for storing an initialization binarization threshold value;

a data correction device, which is connected with the noise identification device, and is used for receiving the five to-be-processed noise types, the initialization binarization threshold value and the type weight comparison table, to determine the five influence coefficients corresponding respectively to the five to-be-processed noise types basing on the type weight comparison table, and to carry out correction processing in sequence on the initialization binarization threshold value by adopting the five influence coefficients, so as to obtain and output the correction threshold value after the correction processing is finished;

a normalization processing device, which is connected with the data correction device, to perform binarization processing on the high-definition panoramic image by adopting the correction threshold value, so as to obtain and output a to-be-detected image;

an image equalization device, which is connected with the normalization processing device, is used for receiving the to-he-detected image, and performing white balance processing on the to-be-detected image, so as to obtain and output a corresponding white balance image;

a component extraction device, which is connected with the image equalization device, is used for receiving the white balance image, and performing average value calculation on the R components of each region of the white balance image, so as to obtain the average value of each R component of each region, wherein the size of each region is the same;

a component analysis device, which is connected with the component extraction device, and is used for receiving the average value of each R component of each region, sorting the average value of each R component of each region, outputting a plurality of regions ranked in front of the preset quantity and a plurality of regions ranked at the end of the preset quantity as various to-be-processed regions, and outputting various regions in the white balance image apart from those to-be-processed regions as various background regions;

a directional sharpening device, which is connected with the component analysis device, is used for receiving the various to-be-processed regions and the various background regions, and performing the following operations for each to-be-processed region: performing corresponding sharpening processing on the to-be-processed regions based on the ambiguity of the to-be-processed regions to obtain the corresponding sharpening processing regions, wherein the greater the degree of ambiguity, the greater the strength of performing the corresponding sharpening processing on the to-be-processed regions will he, and the dynamic distribution range of the to-be-processed regions is used to express the ambiguity, and the wider the dynamic distribution range, the smaller the degree of ambiguity will be;

a data fusion device, which is connected to the directional sharpening device, and is used for receiving a plurality of sharpening processing regions and fusing the plurality of sharpening processing regions with the various background regions to obtain and output a fusion processing image; and

a firecracker detection device, which is connected to the data fusion device, and is used for receiving the fusion processing image, searching for a corresponding firecracker sub-image from the fusion processing image basing on a firecracker image feature, identifying a plurality of firecracker pixels in the firecracker sub-image basing on a preset firecracker upper limit threshold and a preset firecracker lower limit threshold, fitting a plurality of firecracker pixels into a firecracker region, determining the area percentage in the firecracker sub-image occupied by the firecracker region, and sending a firecracker detection signal when the area percentage exceeds a limit.

In the safe heater based on environmental analysis: in the firecracker detection device, a firecracker undetected signal is sent when the area percentage limit is not exceeded.

In the safe heater based on environmental analysis: the power switch is connected with the firecracker detection device, and is used for interrupting connection between the power switch and the 220-volt alternating current when the firecracker detection signal is received.

In the safe heater based on environmental analysis: the power switch is connected with the firecracker detection device, and is used for maintaining the connection between the power switch and the 220-volt alternating current when the undetected signal of the firecracker is received.

In the safe heater based on environmental analysis: calculating the average value of R components of each region of the white balance image in the component extraction device, so as to obtain the average value of each R component of each region, which includes: obtaining the R component values of each pixel point of each region basing on an operation formula of YUV to RGB, sorting the R component values of each pixel point from large to small, and taking the R component value of the pixel point in the center as the average value of R component of the corresponding region.

In the safe heater based on environmental analysis: the image collection device is further used for starting collecting operation of the high-definition panoramic image when receiving an adjustment complete signal sent by the vertical control motor.

Also in the safe heater based on environmental analysis: the embedded processing device calculates the vertical height of the image collection device to the ground based on the current air temperature, the time of ultrasonic signal emitted and the time of ultrasonic signal received, which includes: obtaining a temperature range comparison table from the FLASH storage device, determining a temperature range where the current air temperature is located to obtain a corresponding ultrasonic transmission speed from the temperature speed comparison table to serve as a current transmission speed, and calculating the vertical height of the image collection device to the ground basing on the current transmission speed, the time of ultrasonic signal emitted and the time of ultrasonic signal received.

In addition, the noise identification device is implemented by a CPLD chip. CPLD has the characteristics of being flexible in programming, having a high level of integration, short period of design development, wide range of application, advanced development tool, low cost of design manufacturing, low requirement for designers in hardware experience, no necessity for testing of standard products, high confidentiality, affordable price and the like. Large-scale circuit design can be realized, so it is widely used in prototype design and product production (generally below 10,000 pieces). CPLD device can be applied in almost all applications of medium and small-scale general digital integrated circuits. CPLD device has become an indispensable part for electronic products, and its design and application are necessary skills for electronic engineers.

CPLD is a digital integrated circuit capable of automatically constructing a logic function by a user according to individual needs. The basic design method includes generating a corresponding target file by means of an integrated development software platform, a schematic diagram, a hardware description language and the like, and transmitting the code to a target chip through a download cable (in-system programming) to realize a designed digital system.

The safe heater based on environment analysis of the present invention is used by aiming at the technical problem of uncontrollable fire prevention of heaters in the prior art. The average value of the R components is subjected to intra-region sorting and inter-region sorting, the directional processing mode of the image is determined, and targeted sharpening processing is carried out on each front-ranking image region in ambiguity. A CPLD chip is adopted to realize noise detection and analysis of the image, and basing on this, a data correction device is adopted to perform adaptive correction of the segmentation threshold, so that the accuracy of follow-up detection is improved. The current position of the image collection device is determined by adopting an ultrasonic detection mode, and in order to improve the precision of position detection, a temperature speed comparison table is introduced to store the ultrasonic transmission speed corresponding to each temperature range. Meanwhile, a vertical control motor is adopted to correct the current position of the image collection device in real time, to ensure the quality of collected image. Basing on the data processing, a high-precision customized identification is carried out, on the existence condition of the firecracker around the heater, so that the explosion of the firecracker caused by the heater is avoided, and the technical problem is solved.

It should be understood that while the present invention has been described in terms of preferred embodiments, the above-described embodiments are not intended to limit the present invention. It will be apparent to those skilled in the art that many possible variations and modifications technical solutions of the present invention or amendments to equivalent embodiments can he made without departing from the scope of the technical solutions of the present invention. Therefore, any simple modification, equivalent variation and modification made in the above embodiment which are substantially based on the technology of the present invention without departing from the contents of the technical solution of the present invention, are still within the scope of the technical solution of the present invention.

1-9. (canceled)

10. A safe heater based on environmental analysis, characterized by, the heater comprises:
a heater body, which comprises a housing, a safe metal cover, a reflective cover and a power switch, wherein the power switch is used for connecting a 220V alternating current, the safe metal cover is arranged at the periphery of the reflective cover, and the housing is arranged at the periphery of the safe metal cover;
characterized by, the heater further comprises:
an image collection device for performing panoramic image data collection on the position where the heater body is located so as to obtain and output a corresponding high-definition panoramic image;
an ultrasonic emission device, which is arranged on the image collection device, and is used for emitting an ultrasonic signal towards the ground and recording the time when the ultrasonic signal is emitted;
and an ultrasonic receiving device, which is arranged on the image collection device, is located near the ultrasonic emission device and is used for facing the ground to receive the ultrasonic signal reflected by the ground and emitted by the ultrasonic emission device, and recording the time when the ultrasonic signal reflected by the ground and emitted by the ultrasonic emission device is received.
characterized by, the heater further comprises:
an air temperature detection device, which is arranged on the image collection device, and is used for detecting the air temperature of the environment where the image collection device is located as a current air temperature output;
an embedded processing device, which is arranged on the image collection device, is connected respectively with the air temperature detection device, the ultrasonic emission device and the ultrasonic receiving device, and is used for calculating the vertical height of the image collection device to the ground to be output as the current height based on the current air temperature, the time of ultrasonic signal emitted and the time of ultrasonic signal received;
a FLASH storage device, which is connected with the embedded processing device, and is used for storing a temperature speed comparison table; wherein the temperature speed comparison table is used for storing the ultrasonic transmission speed corresponding to each temperature range; the temperature speed comparison table is using the temperature range as the index value, and the FLASH storage device is further used for storing a preset height, wherein the preset height is the shooting height set by the image collection device;
a vertical control motor, which is connected with the embedded processing device and the image collection device, is used for receiving the current height and the preset height, and controlling the image collection device to adjust the position of the image collection device from the current height to the preset height, wherein the vertical control motor is also used for sending an adjusted signal after adjusting the position of the image collection device from the current height to the preset height;
a noise identification device, which is connected with the image collection device, and is used for receiving the high-definition panoramic image and performing noise type analysis on the high-definition panoramic image to obtain the various noise types and the maximum amplitude corresponding to each noise type in the high-definition panoramic image, sorting the various noise types based on the order of the maximum amplitude from large to small, and taking the five types of noise with largest amplitude as five to-be-processed noise types to be output; and the noise identification device is realized by a CPLD chip, wherein a memory is integrated in the CPLD chip, which is used for storing a type weight comparison table, wherein the type weight comparison table saves the influence coefficient of each noise type on the binarization threshold value, and is further used for storing an initialization binarization threshold value;
a data correction device, which is connected with the noise identification device, and is used for receiving the five to-be-processed noise types, the initialization binarization threshold value and the type weight comparison table, to determine the five influence coefficients corresponding respectively to the five to-be-processed noise types basing on the type weight comparison table, and to carry out correction processing in sequence on the initialization binarization threshold value by adopting the five influence coefficients, so as to obtain and output the correction threshold value after the correction processing is finished;
a normalization processing device, which is connected with the data correction device, to perform binarization processing on the high-definition panoramic image by adopting the correction threshold value, so as to obtain and output a to-be-detected image;
an image equalization device, which is connected with the normalization processing device, is used for receiving the to-be-detected image, and performing white balance processing on the to-be-detected image, so as to obtain and output a corresponding white balance image;
a component extraction device, which is connected with the image equalization device, is used for receiving the white balance image, and performing average value calculation on the R components of each region of the white balance image, so as to obtain the average value of each R component of each region, wherein the size of each region is the same;
a component analysis device, which is connected with the component extraction device, and is used for receiving the average value of each R component of each region, sorting the average value of each R component of each region, outputting a plurality of regions ranked in front of the preset quantity and a plurality of regions ranked at the end of the preset quantity as various to-be-processed regions, and outputting various regions in the white balance image apart from those to-be-processed regions as various background regions;
a directional sharpening device, which is connected with the component analysis device, is used for receiving the various to-be-processed regions and the various background regions, and performing the following operations for each to-be-processed region: performing corresponding sharpening processing on the to-be-processed regions based on the ambiguity of the to-be-processed regions to obtain the corresponding sharpening processing regions, wherein the greater the degree of ambiguity, the greater the strength of performing the corresponding sharpening processing on the to-be-processed regions will be, and the dynamic distribution range of the to-be-processed regions is used to express the ambiguity, and the wider the dynamic distribution range, the smaller the degree of ambiguity will be;
a data fusion device, which is connected to the directional sharpening device, and is used for receiving a plurality of sharpening processing regions and fusing the plurality of sharpening processing regions with the various background regions to obtain and output a fusion processing image; and
a firecracker detection device, which is connected to the data fusion device, and is used for receiving the fusion processing image, searching for a corresponding firecracker sub-image from the fusion processing image basing on a firecracker image feature, identifying a plurality of firecracker pixels in the firecracker sub-image basing on a preset firecracker upper limit threshold and a preset firecracker lower limit threshold, fitting a plurality of firecracker pixels into a firecracker region, determining the area percentage in the firecracker sub-image occupied by the firecracker region, and sending a firecracker detection signal when the area percentage exceeds a limit.

11. A safe heater based on environmental analysis according to claim 10, characterized by:
in the firecracker detection device, a firecracker undetected signal is sent when the area percentage limit is not exceeded.

12. A safe heater based on environmental analysis according to claim 11, characterized by:
the power switch is connected with the firecracker detection device, and is used for interrupting connection between the power switch and the 220-volt alternating current when the firecracker detection signal is received.

13. A safe heater based on environmental analysis according to claim 12, characterized by:
the power switch is connected with the firecracker detection device, and is used for maintaining the connection between the power switch and the 220-volt alternating current when the undetected signal of the firecracker is received.

14. A safe heater based on environmental analysis according to claim 13, characterized by:
calculating the average value of R components of each region of the white balance image in the component extraction device, so as to obtain the average value of each R component of each region, which includes: obtaining the R component values of each pixel point of each region basing on an operation formula of YUV to RGB, sorting the R component values of each pixel point from large to small, and taking the R component value of the pixel point in the center as the average value of R component of the corresponding region.

15. A safe heater based on environmental analysis according to claim 14, characterized by:
the image collection device is further used for starting collecting operation of the high-definition panoramic image when receiving an adjustment complete signal sent by the vertical control motor.

16. A safe heater based on environmental analysis according to claim 15, characterized by:
The embedded processing device calculates the vertical height of the image collection device to the ground based on the current air temperature, the time of ultrasonic signal emitted and the time of ultrasonic signal received, which includes: obtaining a temperature range comparison table from the FLASH storage device, determining a temperature range where the current air temperature is located to obtain a corresponding ultrasonic transmission speed from the temperature speed comparison table to serve as a current transmission speed, and calculating the vertical height of the image collection device to the ground basing on the current transmission speed, the time of ultrasonic signal emitted and the time of ultrasonic signal received.
